(19) United States
(12) Patent Application Publication
(10) Pub. No.: US 2019/0132710 A1
(43) Pub. Date: May 2, 2019

(54) TECHNIQUES FOR IMPLEMENTING A SECRET MODE IN A SOCIAL NETWORKING SYSTEM

(71) Applicant: Facebook, Inc., Menlo Park, CA (US)

(72) Inventors: Christopher Anthony Leach, San Carlos, CA (US); Valerie Chao, San Francisco, CA (US); Jonathan Smiley, San Jose, CA (US); Jason Wei, San Francisco, CA (US); Gabriela Alcala Murga, Redwood City, CA (US)

(21) Appl. No.: 15/800,805

(22) Filed: Nov. 1, 2017

(51) Int. Cl. H04W 4/08; H04L 12/58; G06Q 50/00

(52) U.S. Cl. CPC H04W 4/08; G06Q 50/01; H04L 51/12; H04L 51/32

(57) ABSTRACT

The present disclosure relates to implementing a secret mode in a social networking system. The secret mode provides a separate space for users to share and interact with particular friends. To implement the secret mode, each user may have a feed that is separate from the user's primary feed, the feed sometimes referred to as a secondary feed. Accordingly, a first user and a second user may each have a secondary feed. The first user may identify the second user as included in an audience of the first user. Based on the second using being included in the audience of the first user, content posted to the audience of the first user may be sent to the secondary feed of the second user such that the second user may view the content.

### BACKGROUND

A social networking system (SNS) may enable its users to interact with and share information with each other through the SNS. For example, a user may post content that may be viewed by one or more other users of the SNS. Typically, the posted content is shared between users that are connected to each other. Such a connection may be established by a first user requesting to be connected to a second user, and the second user accepting the connection. However, social networking systems are always looking for new ways to allow users to connect.

### SUMMARY

The present disclosure relates generally to facilitating communications between users of a social networking system (SNS), and more particularly to a new type of connection between a pair of users. The new type of connection may be established when a first user causes a unidirectional connection (sometimes referred to as one way) to be added from the first user to the second user, where the direction of the connection indicates the flow of content.

In some embodiments, the new type of connection may be included in a secret mode provided by the SNS. The secret mode may provide a separate space for users to share and interact with users based upon the new type of connection. To implement the secret mode, each user may have a secondary feed that is separate from the user's primary feed. The first user may identify the second user as included in an audience of the first user. Based on the second user being included in the audience of the first user, content posted to the audience of the first user by the first user may be sent to the secondary feed of the second user such that the second user may view the content.

In some embodiments, the content may be sent to the secondary feed of the second user without the second user approving the inclusion of the second user in the audience of the first user. For example, the first user may add herself to the second user's secondary feed without the second user's acceptance.

In one illustrative example, a user may have two feeds: a primary feed and a secondary feed. The primary feed may receive content from the user's friends, and the secondary feed may receive content from the user's friends that added the user to their audience. In such an example, the user may add herself to a friend's secondary feed. The friend's secondary feed may then immediately start to receive content shared by the user to the user's audience. In some examples, the content may be received in the friend's secondary feed without the friend having to accept the user on the friend's secondary feed. Accordingly, a user that is viewing their own secondary feed may see content from their friends that have added themselves to the user's secondary feed.

In some embodiments, a user may navigate between their primary feed and their secondary feed to view content from each feed. In other embodiments, content from each feed may be combined into a single feed, where content from a particular feed includes an indication of a particular feed. In either set of embodiments, users may cross-post between their primary feed and their audience. For example, a user may share content included on the user's primary feed to secondary feeds of the user's friends (i.e., the user may share the content to the user's audience).

In some embodiments, the secret mode may have its own social graph and interface such that the secret mode is essentially a duplicate instance of the SNS within the SNS. In some embodiments, posts from a user to their friends' secondary feeds may be available for view by their friends for a limited amount of time. The limited amount of time may be an amount specified by the SNS or the user (e.g., 30 days). After the time has expired, the posts may be stored and viewable only by the user that posted them. In some examples, the posts may be stored in a separate space than other posts. For example, the user may navigate to the separate space to view the posts that have viewable only by the user. The friends may then only have access to the posts when the user reposts them. The user may repost a post using the separate space described above.

According to embodiments described above, techniques may be provided for establishing a unidirectional connection between users of a SNS. For example, techniques may include a SNS receiving a request to add a second user of the SNS to an audience of the first user. The request may be sent to the SNS by a first user of the SNS.

In response to the request, a unidirectional connection may be added to a social graph stored by the SNS. The unidirectional connection may be from the first user to the second user. In some examples, the unidirectional connection may establish that content is configured to be sent from the first user to the second user based upon the unidirectional connection. The unidirectional connection may further establish that content is not able to be sent from the second user to the first user based upon the unidirectional connection. In some examples, the unidirectional connection may be added to the social graph without an action by the second user.

In some examples, the social graph may include connections between users of the SNS. In such examples, a bidirectional connection may be included in the social graph, where the bidirectional connection establishes that content is configured to be sent between a user of the SNS and another user of the SNS based upon the bidirectional connection.

In some examples, a plurality of feeds may be associated with the second user, where the plurality of feeds include a primary feed and a secondary feed. The primary feed may include content sent based upon a bidirectional connection between a user of the SNS and the second user, and the secondary feed may include content sent based upon a unidirectional connection from a user of the SNS to the second user. In some examples, the secondary feed may include content from a plurality of users of the SNS, where each of the plurality of users has added the second user to their own audience.

In some examples, the first user and the second user may be connected by a bidirectional connection in the social graph in addition to the unidirectional connection, where the bidirectional connection is established at the same time or before the unidirectional connection. As described above, the bidirectional connection may establish that (1) content is configured to be sent from the first user to the second user based upon the bidirectional connection (2) content is configured to be sent from the second user to the first user based upon the bidirectional connection.

According to embodiments described above, techniques may be provided for sending content between users of a SNS based upon a unidirectional connection. For example, techniques may include a SNS receiving content sent to an audience of a first user of the SNS. In such an example, the audience may include one or more users of the SNS, each user of the one or more users connected to the first user by a unidirectional connection from the first user to the user. The unidirectional connection may establish that (1) content is configured to be sent from the first user to the user based upon the unidirectional connection and (2) content is not able to be sent from the user to the first user based upon the unidirectional connection.

In response to receiving the content sent to the audience, the SNS may identify the one or more users included in the audience. Then, for each user of the one or more users, the content may be sent to the user based upon a unidirectional connection from the first user to the user. In some examples, the unidirectional connection may be established from the first user to the user without an action by the user.

In some examples, each of the one or more users may also be connected to the first user by a bidirectional connection, where the bidirectional connection is established at the same time or before the unidirectional connection. The bidirectional connection may establish that (1) content is configured to be sent from the first user to the user based upon the bidirectional connection and (2) content is able to be sent from the user to the first user based upon the bidirectional connection.

In some examples, a plurality of feeds may be associated with the first user, where the plurality of feeds include a primary feed and a secondary feed. The primary feed may include content sent based upon a bidirectional connection between the first user and another user, and the secondary feed may include content sent based upon a unidirectional connection from another user to the first user. In such examples, the first user may send the content to the audience from the primary feed. The secondary feed may include content from a plurality of users of the SNS that have added the first user to their own audiences.

In some examples, the content sent to the audience may be included in a feed associated with a user for an amount of time, where, upon expiration of the time, the content is removed from the feed such that the user is not able to view the content. In such examples, when the content is removed from the feed associated with the user, the content may be configured such that only the first user may view the content.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of a distributed system with a user device and a social networking system according to certain embodiments.

FIG. 2A is a diagram illustrating a social graph with bidirectional connections between users of a social networking system according to certain embodiments.

FIG. 2B is a diagram illustrating a social graph with unidirectional connections between users of a social networking system according to certain embodiments.

FIG. 3 depicts a user interface with a feed from a social networking system according to certain embodiments.

FIG. 4 depicts a user interface for a secret mode of a social networking system according to certain embodiments.

FIG. 5 is a simplified flowchart depicting processing performed by a social networking system to add a unidirectional connection according to certain embodiments.

FIG. 6A is a diagram illustrating a social graph with bidirectional connections and unidirectional connections between users of a social networking system according to certain embodiments.

FIG. 6B is a diagram illustrating a social graph with unidirectional connections between users of a social networking system according to certain embodiments.

FIG. 7 is a simplified flowchart depicting processing performed by a social networking system to send content based upon a unidirectional connection according to certain embodiments.

FIG. 8A depicts a user interface with a primary feed and a secondary feed for a user of a social networking system according to certain embodiments.

FIG. 8B depicts a user interface with a combined feed for a user of a social networking system according to certain embodiments.

FIG. 9 illustrates an example of a computer system that may be used to implement certain embodiments described herein.

### DETAILED DESCRIPTION

The present disclosure relates generally to facilitating communications between users of a social networking system (SNS), and more particularly to a new type of connection between a pair of users. The new type of connection may be established when a first user causes a unidirectional connection (sometimes referred to as one way) to be added from the first user to the second user, where the direction of the connection indicates the flow of content.

In some embodiments, the new type of connection may be included in a secret mode provided by the SNS. The secret mode may provide a separate space for users to share and interact with users based upon the new type of connection. To implement the secret mode, each user may have a secondary feed that is separate from the user's primary feed. The first user may identify the second user as included in an audience of the first user. Based on the second user being included in the audience of the first user, content posted to the audience of the first user by the first user may be sent to the secondary feed of the second user such that the second user may view the content.

In some embodiments, the content may be sent to the secondary feed of the second user without the second user approving the inclusion of the second user in the audience of the first user. For example, the first user may effectively add herself to the second user's secondary feed without the second user's acceptance.

In one illustrative example, a user may have two feeds: a primary feed and a secondary feed. The primary feed may receive content from the user's friends, and the secondary feed may receive content from the user's friends that added the user to their audience. In such an example, the user may add herself to a friend's secondary feed. The friend's secondary feed may then immediately start to receive content shared by the user to the user's audience. In some examples, the content may be received in the friend's secondary feed without the friend having to accept the user on the friend's secondary feed. Accordingly, a user that is viewing their own secondary feed may see content from their friends that have added themselves to the user's secondary feed.

In some embodiments, a user may navigate between their primary feed and their secondary feed to view content from each feed. In other embodiments, content from each feed may be combined into a single feed, where content from a particular feed includes an indication of a particular feed. In either set of embodiments, users may cross-post between their primary feed and their audience. For example, a user may share content included on the user's primary feed to secondary feeds of the user's friends (i.e., the user may share the content to the user's audience).

In some embodiments, the secret mode may have its own social graph and interface such that the secret mode is essentially a duplicate instance of the SNS within the SNS. In some embodiments, posts from a user to their friends' secondary feeds may be available for view by their friends for a limited amount of time. The limited amount of time may be an amount specified by the SNS or the user (e.g., 30 days). After the time has expired, the posts may be stored and viewable only by the user that posted them. In some examples, the posts may be stored in a separate space than other posts. For example, the user may navigate to the separate space to view the posts that have viewable only by the user. The friends may then only have access to the posts when the user reposts them. The user may repost a post using the separate space described above.

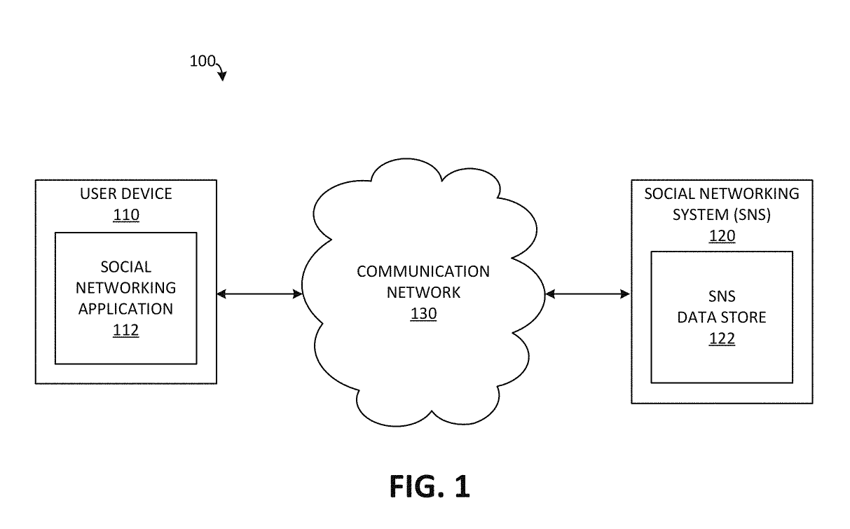

FIG. 1 is a simplified block diagram of distributed system 100 with user device 110 and social networking system (SNS) 120 according to certain embodiments. However, distributed system 100 is merely an example and is not intended to unduly limit the scope of inventive embodiments recited in the claims. One of ordinary skill in the art would recognize many possible variations, alternatives, and modifications. For example, in some implementations, distributed system 100 may have more or fewer systems than those shown in FIG. 1, may combine two or more systems, or may have a different configuration or arrangement of systems. For another example, while distributed system 100 includes a single user device (i.e., user device 110), distributed system 100 may include multiple user devices, each user device communicatively coupled to SNS 120.

User device 110 may be communicatively coupled to SNS 120 via one or more communication networks (e.g., communication network 130). Examples of communication networks include, without restriction, the Internet, a wide area network (WAN), a local area network (LAN), an Ethernet network, wireless wide-area networks (WWANs), wireless local area networks (WLANs), wireless personal area networks (WPANs), a public or private network, a wired network, a wireless network, and the like, and combinations thereof. Different communication protocols may be used to facilitate communications including both wired and wireless protocols such as IEEE 802.XX suite of protocols, TCP/IP, IPX, SAN, AppleTalk®, Bluetooth®, InfiniBand, RoCE, Fiber Channel, Ethernet, User Datagram Protocol (UDP), Asynchronous Transfer Mode (ATM), token ring, frame relay, High Level Data Link Control (HDLC), Fiber Distributed Data Interface (FDDI), and/or Point-to-Point Protocol (PPP), and others. A WWAN may be a network using an air interface technology, such as, a code division multiple access (CDMA) network, a Time Division Multiple Access (TDMA) network, a Frequency Division Multiple Access (FDMA) network, an OFDMA network, a Single-Carrier Frequency Division Multiple Access (SC-FDMA) network, a WiMax (IEEE 802.16), and so on. A WLAN may include an IEEE 802.11x network (e.g., a Wi-Fi network). A WPAN may be a Bluetooth network, an IEEE 802.15x, or some other types of network.

SNS 120 may enable its users to interact with and share information with each other through various interfaces provided by SNS 120. To use SNS 120, a user typically has to register with SNS 120. As a result of the registration, SNS 120 may create and store information in SNS data store 122 about the user, often referred to as a user profile. The user profile may include the user's identification information, background information, employment information, demographic information, communication channel information, personal interests, or other suitable information.

SNS 120 may also store various types of content in SNS data store 122, the content including but not limited to posts, pages, groups, events, photos, videos, apps, and other content provided by users of SNS 120.

Information stored by SNS 120 for a user may be updated based upon the user's interactions with SNS 120 and other users of SNS 120. For example, a user may add connections to any number of other users of SNS 120 to whom they desire to be connected. The term “friend” is sometimes used to refer to any other users of SNS 120 to whom a user has formed a connection, association, or relationship via SNS 120. Connections may be added explicitly by a user or may be automatically created by SNS 120 based upon common characteristics of the users (e.g., users who are alumni of the same educational institution).

An example of a connection is a bidirectional connection. A bidirectional connection may allow content to be sent back and forth between users associated with the bidirectional connection. In some examples, a bidirectional connection may be established when (1) a first user invites a second user to be a friend of the first user and (2) the second user accepts the invitations from the first user. In other examples, the bidirectional connection may be established by an action by either the first user or the second user.

Another example of a connection between users is a unidirectional connection. A unidirectional connection may be established from a first user to a second user. In such an example, the unidirectional connection may establish the following: (1) allow content to be sent from the first user to the second user based upon the unidirectional connection and (2) not allow content to be sent from the second user to the first user based upon the unidirectional connection. In some examples, a unidirectional connection from a first user to a second user may be established when the second user requests to follow the first user. In such examples, the unidirectional connection may be established in response to the request with or without an acceptance by the first user.

SNS 120 may also store information in SNS data store 122 related to the user's interactions and relationships with other concepts (e.g., users, groups, posts, pages, events, photos, audiovisual content (e.g., videos), apps, etc.) in SNS 120. For example, SNS 120 may store the information in a social graph. The social graph may include nodes representing individuals, groups, organizations, or the like. The edges between the nodes may represent one or more specific types of interdependencies or interactions between the concepts. SNS 120 may use this stored information to provide various services (e.g., wall posts, photo sharing, event organization, messaging, games, advertisements, or the like) to its users to facilitate social interaction between users using SNS 120. In one embodiment, if users of SNS 120 are represented as nodes in the social graph, the term “friend” may refer to an edge formed between and directly connecting two user nodes.

SNS 120 may facilitate linkages between a variety of concepts, including users, groups, etc. These concepts may be represented by nodes of the social graph interconnected by one or more edges. A node in the social graph may represent a concept that may act on another node representing another concept and/or that may be acted on by the concept corresponding to the another node. A social graph may include various types of nodes corresponding to users, non-person concepts, content items, web pages, groups, activities, messages, and other things that may be represented by objects in SNS 120. An edge between two nodes in the social graph may represent a particular kind of connection, or association, between the two nodes, which may result from node relationships or from an action that was performed by a concept represented by one of the nodes on a concept represented by the other node. In some cases, the edges between nodes may be weighted. In certain embodiments, the weight associated with an edge may represent an attribute associated with the edge, such as a strength of the connection or association between nodes. Different types of edges may be provided with different weights. For example, an edge created when one user “likes” another user may be given one weight, while an edge created when a user befriends another user may be given a different weight.

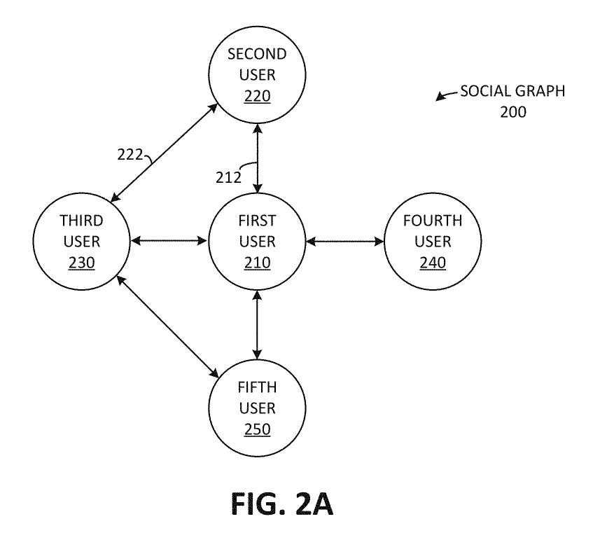

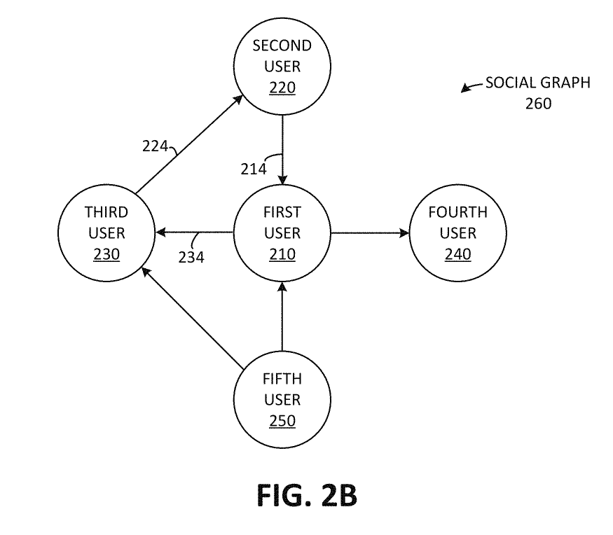

FIG. 2A is a diagram illustrating social graph 200 with bidirectional connections between users of a social networking system (SNS) according to certain embodiments. Social graph 200 includes multiple users, each user including at least one bidirectional connection. For example, first user 210 may have a bidirectional connection with second user 220 (i.e., bidirectional connection 212), third user 230, fourth user 240, and fifth user 250. For another example, second user 220 may have a bidirectional connection with first user 210 (i.e., bidirectional connection 212) and third user 230 (i.e., bidirectional connection 222). For another example, third user 230 may have a bidirectional connection with first user 210, second user 220 (i.e., bidirectional connection 222), and fifth user 250. For another example, fourth user 240 may have a bidirectional connection with first user 210. For another example, fifth user 250 may have a bidirectional connection with first user 210 and third user 230.

In some examples, a bidirectional connection may be established by either user associated with the bidirectional connection. For example, either first user 210 or second user 220 may request to add bidirectional connection 212. In response to the request, bidirectional connection 212 may be added to social graph 200. While bidirectional connection 212 may be added without a user accepting the request, some examples may require that both users agree to bidirectional connection 212. For example, first user 210 may request bidirectional connection 212 and second user 220 may accept the request.

FIG. 2B is a diagram illustrating social graph 260 with unidirectional connections between users of a social networking system (SNS) according to certain embodiments. Social graph 260 includes multiple users, some of which may include at least one unidirectional connection. For example, first user 210 may have a unidirectional connection from first user 210 to each of third user 230 (i.e., unidirectional connection 234) and fourth user 240. For another example, second user 220 may have a unidirectional connection from second user 220 to first user 210 (i.e., unidirectional connection 214). For another example, third user 230 may have a unidirectional connection from third user 230 to second user 220 (i.e., unidirectional connection 224). For another example, fifth user 250 may have a unidirectional connection from fifth user 250 to each of first user 210 and third user 230.

In some examples, a unidirectional connection may be a user requesting to receive content based upon the unidirectional connection. For example, first user 210 may request to add unidirectional connection 214 from second user 220 to first user 210. In response to the request, unidirectional connection 214 may be added to social graph 200. While unidirectional connection 214 may be added without second user 220 accepting the request, some examples may require that second user 220 accept the request. Other examples may present an option to second user 220 to deny unidirectional connection 214. In such examples, unidirectional connection 214 may be established until second user 220 denies unidirectional connection 214.

Referring back to FIG. 1, user device 110 may sometimes be referred to as a client device, or simply a client. User device 110 may be a computing device, such as, for example, a mobile phone, a smart phone, a personal digital assistant (PDA), a tablet computer, an electronic book (e-book) reader, a gaming console, a laptop computer, a netbook computer, a desktop computer, a thin-client device, a workstation, etc.

One or more applications (“apps”) may be hosted and executed by user device 110. The apps may be web browser-based applications or other types of applications. In the example embodiment depicted in FIG. 1, user device 110 hosts and executes social networking application 112, which enables a user to interact with SNS 120. For example, a user using user device 110 may log into or register with SNS 120, post content to and share content with other users of SNS 120, access and interact with content and services provided by SNS 120, and the like using social networking application 112.

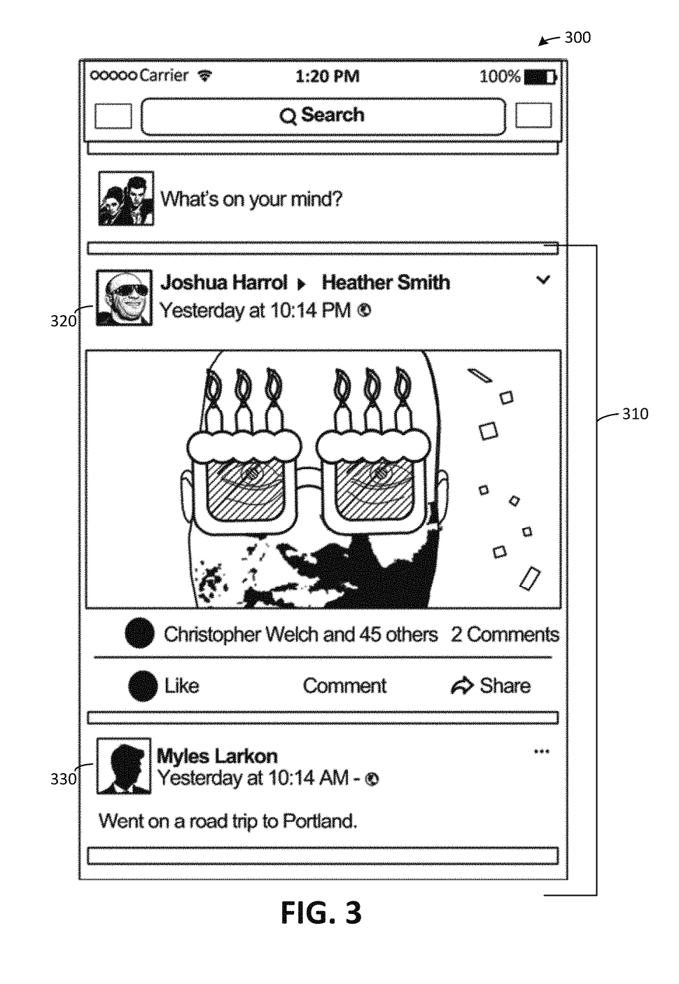

FIG. 3 depicts user interface 300 with feed 310 from a social networking system (SNS) according to certain embodiments. User interface 300 may be presented by a social networking application (e.g., social networking application 112 in FIG. 1) of a user device (e.g., user device 110). The social networking application may be logged in as a first user of the SNS.

The first user may have one or more connections with one or more other users of the SNS. For example, the first user may have a bidirectional connection with a second user of the SNS. For another example, the second user may have a unidirectional connection from the second user to the first user.

Such connections as described above may cause content posted by the second user to be communicated to the first user. The content may be communicated to feed 310 such that the social networking application presents content from one or more users connected to the first user. For example, first content 320 in feed 310 may be a message from a second user to a third user. The message may be indicated by the second user and/or the third user as shareable to friends of the second user and/or the third user. In such an example, the first user may be a friend of the second user and/or the third user. The friendship may be indicated by a bidirectional connection between the first user and the user that the first user is a friend of. In addition to first content 320, feed 310 may further include content 330, which may be from a fifth user. The fifth user may have posted content 330 to their wall, which may be configured to be sent to friends of the fifth user. In such an example, the first user may be a friend of the fifth user.

In some examples, a social networking system (SNS) may provide a secret mode. The secret mode may provide a separate space for users of the SNS to share and interact with particular users. To implement the secret mode, each user may have a secondary feed that is separate from the user's primary feed.

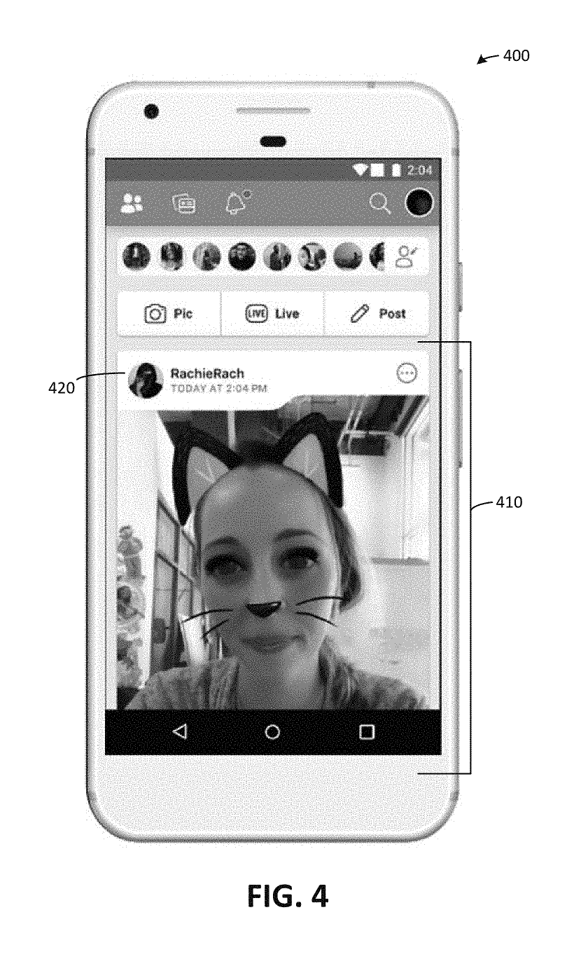

FIG. 4 depicts user interface 400 for a secret mode of a social networking system (SNS) according to certain embodiments. The secret mode may be provided for a first user by the SNS in addition to a regular mode, as illustrated in FIG. 3. The first user may be logged into a device presenting user interface 400.

The secret mode may include content from a subset of users as compared to the regular mode. For example, the first user may have 100 friends. The regular mode, as illustrated in FIG. 3, may potentially include content from any of the 100 friends. The secret mode, as illustrated in FIG. 4, may be associated with 20 friends of the 100 friends. Accordingly, the secret mode may potentially include content from any of the 20 friends.

Content included in the secret mode may be included in secondary feed 410. For example, secondary feed 410 may include content 420, which may be from a second user. In some examples, the second user may be selected by the first user to have the second user's content included in secondary feed 410. In other examples, the second user may select the first user to have the second user's content included in secondary feed 410. Secondary feed 410 may be separate from feed 310 illustrated in FIG. 3.

As can be seen in FIG. 4, a look and feel of the secret mode may be different than the regular mode. For example, the secret mode may include a different layout, user interface, and/or color scheme. The secret mode may also include a different social graph than is used for the regular mode. For example, a first social graph may include connections that are used for the regular mode and a second social graph may include connections that are used for the private mode.

In some examples, the first user may be identified different in the secret mode. For example, the first user may have a different username (and/or screenname) and associated information while in the private mode. In some examples, the private mode may only include content from a set of users associated with the private mode. In such examples, other content (such as public content) might not be shown. In some examples, a number of users that may be added to a user's audience may be limited to a particular number.

In some examples, the private mode may only allow users to share content and may not allow users to interact with content (e.g., comment, react, etc.). In other examples, only a user posting content may view interactions by other users with the content.

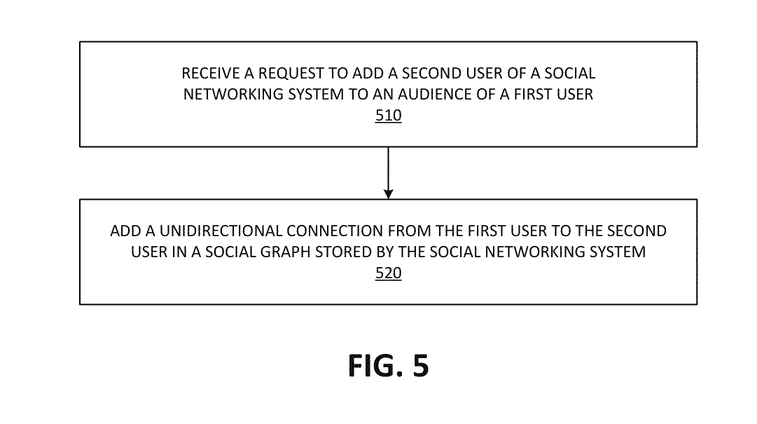

A new type of connection introduced by the secret mode may be a unidirectional connection from the first user to a second user, the unidirectional connection established in response to the first user sending a request to add the unidirectional connection from the first user to the second user. The process to add such a connection is further described below in FIG. 5.

FIG. 5 is a simplified flowchart depicting processing performed by a social networking system (SNS) to add a unidirectional connection according to certain embodiments. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain embodiments, the steps may be performed in some different order or some steps may also be performed in parallel.

In the embodiment depicted in FIG. 5, the processing may be triggered at 510 when a request is received to add a second user to an audience of a first user. The request may be received by the SNS from the first user. The audience may include one or more users that receive content that the first user posts to the audience. In some examples, in order to send the request, the first user may have to be connected to the second user (e.g., the first user and the second user may be connected to each other by a bidirectional connection). If the unidirectional connection is requested when the bidirectional connection is requested, the unidirectional connection may proceed after the bidirectional connection has been accepted.

At 520, a unidirectional connection from the first user to the second user may be added to a social graph stored by the SNS. The social graph may be the same or different social graph that includes other connections of the SNS (such as bidirectional connections). The unidirectional connection may cause content to be sent from the first user to the second user but not content to be sent from the second user to the first user based upon the unidirectional connection.

The unidirectional connection described herein may be different than a unidirectional connection added based upon a follow request. For example, the unidirectional connection described herein may be in response to a first user requesting to add the second user to an audience of the first user. A unidirectional connection added based upon a follow request would be different because it would be the second user that requests the unidirectional connection to be added (i.e., the second user would request to follow the first user).

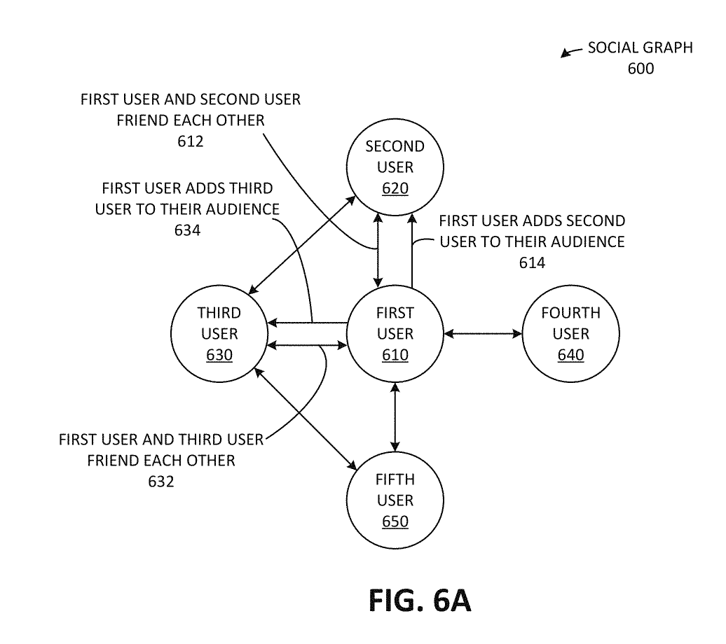

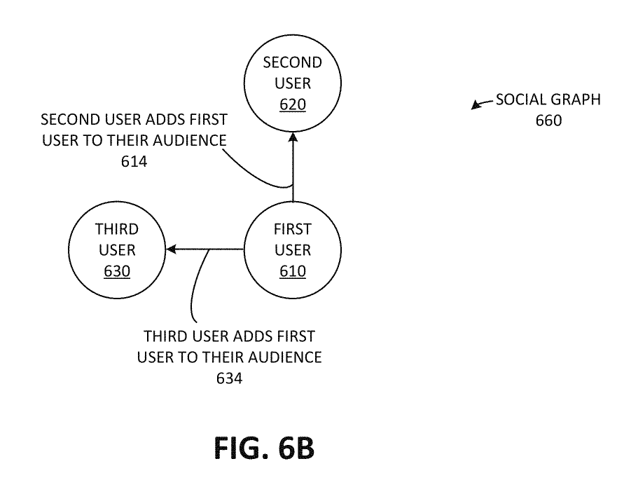

FIG. 6A is a diagram illustrating social graph 600 with bidirectional connections and unidirectional connections between users of a social networking system (SNS) according to certain embodiments. Social graph 600 includes multiple users, each user including at least one connection (e.g., a bidirectional connection or a unidirectional connection). For example, first user 610 may have a bidirectional connection with second user 620 (i.e., bidirectional connection 612), third user 630, fourth user 640, and fifth user 650. Bidirectional connection 612 may be established in response to either first user 610 or second user 620 friending the other user (and, in some examples, the other user accepting the friendship). For another example, second user 620 may have a bidirectional connection with first user 610 (i.e., bidirectional connection 612) and third user 630. For another example, third user 630 may have a bidirectional connection with first user 610 (i.e., bidirectional connection 632), second user 620, and fifth user 650. Bidirectional connection 632 may be established in response to either first user 610 or third user 630 friending the other user (and, in some examples, the other user accepting the friendship). For another example, fourth user 640 may have a bidirectional connection with first user 610. For another example, fifth user 650 may have a bidirectional connection with first user 610 and third user 630.

First user 610 may also have one or more unidirectional connections with users. For example, first user 610 may have unidirectional connection 614 from first user 610 to second user 620. Unidirectional connection 614 may be established in response to first user 610 adding second user 620 to an audience of first user 610. For another example, first user 610 may have unidirectional connection 634 from first user 610 to third user 630. Unidirectional connection 634 may be established in response to first user 610 adding third user 630 to the audience of first user 610.

As depicted in FIG. 6A, both bidirectional connections and unidirectional connections may be added to a single social graph. However, in other embodiments, bidirectional connections may be added to a first social graph and unidirectional connections may be added to a second social graph, as described in FIG. 6B.

FIG. 6B is a diagram illustrating social graph 660 with unidirectional connections between users of a social networking system (SNS) according to certain embodiments. Social graph 660 may be stored by the SNS in addition to social graph 260 depicted in FIG. 2B. Social graph 660 includes multiple users, each user associated with at least one unidirectional connection. For example (as described above), first user 610 may have unidirectional connection 614 from first user 610 to second user 620. Unidirectional connection 614 may be established in response to first user 610 adding second user 620 to an audience of first user 610. For another example, first user 610 may have unidirectional connection 634 from first user 610 to third user 630. Unidirectional connection 634 may be established in response to first user 610 adding third user 630 to the audience of first user 610.

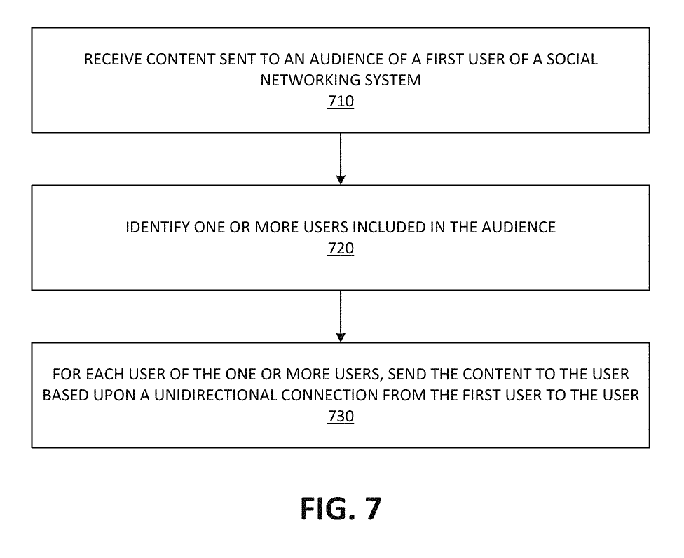

FIG. 7 is a simplified flowchart depicting processing performed by a social networking system (SNS) to send content based upon a unidirectional connection according to certain embodiments. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain embodiments, the steps may be performed in some different order or some steps may also be performed in parallel.

In the embodiment depicted in FIG. 7, the processing may be triggered at 710 when content is received by the SNS. The content may have been sent to an audience of a first user of the SNS. In some examples, each user of the one or more users may be connected to the first user by a unidirectional connection from the first user to the user. The unidirectional connection may establish that content is able to be sent from the first user to the user based upon the unidirectional connection. The unidirectional connection may further establish that content is not able to be sent from the user to the first user based upon the unidirectional connection. In some examples, a unidirectional connection may be established from the first user to a second user without an action by the second user.

At 720, one or more users included in the audience of the first user may be identified. Each user of the one or more users may have been added to the audience by the first user. In some examples, each of the one or more users may also be connected to the first user by a bidirectional connection. The bidirectional connection may be established at the same time or before the unidirectional connection (requiring that the bidirectional connection is present to add the unidirectional connection). The bidirectional connection may establish that content is able to be sent from the first user to the user based upon the bidirectional connection. The bidirectional connection may further establish that content is able to be sent from the user to the first user based upon the bidirectional connection.

At 730, for each user of the one or more users, the content may be sent to the user based upon a unidirectional connection from the first user to the user. In some examples, a plurality of feeds may be associated with the first user, where the plurality of feeds include a first feed and a second feed. The first feed may include content sent based upon a bidirectional connection between the first user and another user, and the second feed may include content sent based upon a unidirectional connection from another user to the first user. In some examples, the first user may send the content to the audience from the first feed. In some examples, the second feed may include content from multiple users of the social networking system that have added the first user to their own audience.

In some examples, the content may be included in a feed associated with a user for an amount of time, where upon expiration of the time, the content is removed from the feed such that the user is not able to view the content. In such examples, when the content is removed from the feed associated with the user, the content may be configured such that only the first user may view the content. For example, the content may be stored and/or presented to the user separately from other content stored and/or presented to the user. In one illustrative example, after thirty days, the content may be archived into a separate space that only the user that shared the content may access.

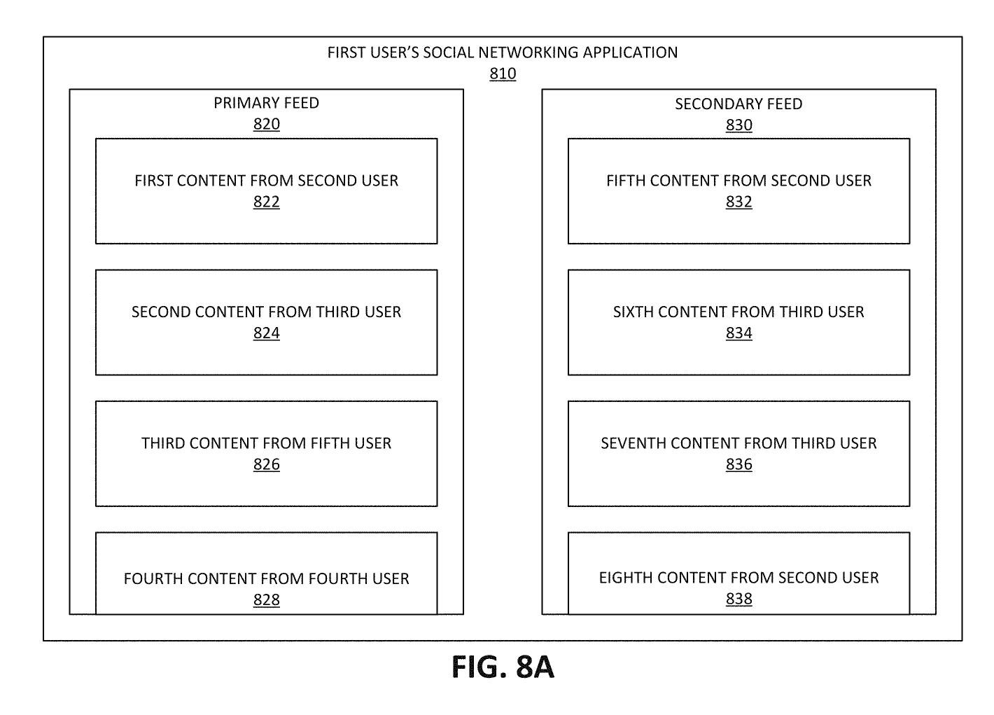

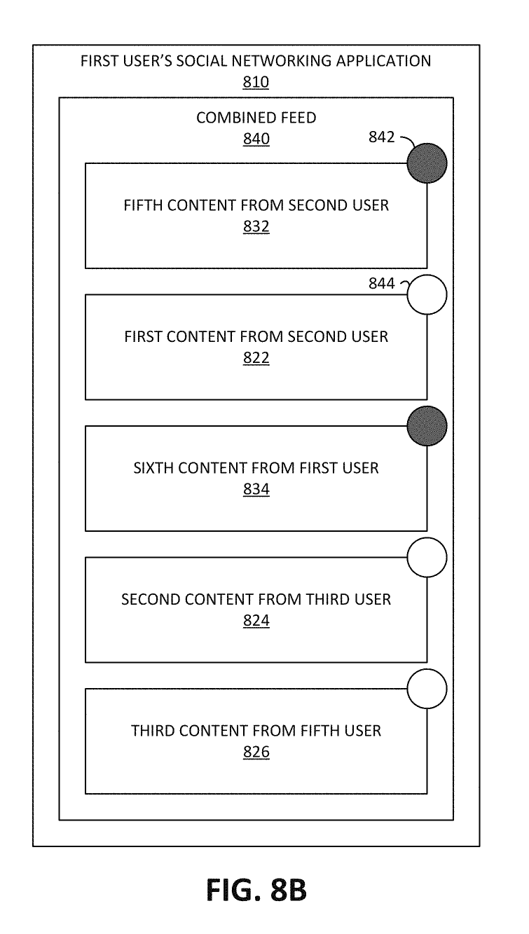

FIG. 8A depicts a user interface with primary feed 820 and secondary feed 830 for a user of a social networking system (SNS) according to certain embodiments. The user interface may be presented by social networking application 810 when the user is logged into an account for a first user.

Primary feed 820 may be associated with a first set of one or more users of the SNS. The first set may be users that the first user has indicated to be associated with primary feed 820. For example, each user in the first set may have a bidirectional connection with the first user. For another example, the first user may select a subset of one or more users that have a bidirectional connection with the first user to be associated with primary feed 820.

Primary feed 820 may include content associated with the first set. For example, primary feed 820 may include first content 822, which may have been posted by a second user of the SNS. Other examples of content that may be included in primary feed 820 include second content 824 (posted by a third user of the SNS), third content 826 (posted by a fifth user of the SNS), and fourth content 828 (posted by a fourth user of the SNS). While content from four users is illustrated to be included in primary feed 820, it should be recognized that content from more or less users may be included in primary feed 820. In addition, while not shown, some content may be posted by the first user that is included in primary feed 820. Also, more than one piece of content may be included from each user. In some examples, the content included in primary feed 820 may be determined based upon a proximity that content is posted in relation to a current time. In other examples, the content included in primary feed 820 may be determined based upon a user profile of the first user. Examples of content include images, videos, messages, links, requests, posts, or the like.

In some examples, when the first user navigates to the user interface, social networking application 810 may request primary feed 820 from the SNS. In response to the request, the SNS may send content (e.g., first content 822) to be populated in primary feed 820. In some examples, primary feed 820 may be scrollable such that some content is hidden by view. When primary feed 820 is scrollable, some content that is hidden may be retrieved from the SNS when primary feed 820 is scrolled.

Secondary feed 830 may be associated with a second set of one or more users of the SNS, the second set including less users than the first set. The second set may be users that the first user has indicated to be associated with secondary feed 830. For example, each user in the second set may have been added by the first user to an audience of the first user (which would add a unidirectional connection from the user to the first user).

Secondary feed 830 may include content associated with the second set. For example, secondary feed 830 may include fifth content 832, which may have been posted by the second user. Other examples of content that may be included in secondary feed 830 include sixth content 834 (posted by the third user), seventh content 836 (posted by the third user), and eighth content 838 (posted by a fourth user of the SNS). While content from four users is illustrated to be included in secondary feed 830, it should be recognized that content from more or less users may be included in secondary feed 830. In some examples, content included in secondary feed 830 may be posted by a user from their own primary feed or secondary feed. In such examples, embodiments allow users to cross post between the two feeds to share content to particular sets of users. Also, more than one piece of content may be included from each user. In some examples, the content included in secondary feed 830 may be determined based upon a proximity that content is posted in relation to a current time. In other examples, the content included in secondary feed 830 may be determined based upon a user profile of the first user.

Similar to primary feed 820, when the first user navigates to the user interface, social networking application 810 may request secondary feed 830 from the SNS. In response to the request, the SNS may send content (e.g., fifth content 832) to be populated in secondary feed 830. Secondary feed 830 may operate similarly to primary feed 820 with regard to scrolling.

While FIG. 8A depicts primary feed 820 and secondary feed 830 visible at the same time in the user interface, it should be recognized that primary feed 820 and secondary feed 830 may each be presented to a user separately. For example, primary feed 820 may be presented in a first user interface and secondary feed 830 may be presented in a second user interface, where the first user may navigate from the first user interface to the second user interface.

FIG. 8B depicts a user interface with combined feed 840 for a user of a social networking system according to certain embodiments. The user interface may be presented by social networking application 810 when the user is logged into an account for a first user.

Combined feed 840 may include content from multiple feeds, including a primary feed (as described above for primary feed 820 in FIG. 8A) and a secondary feed (as described above for secondary feed 830 in FIG. 8A). Accordingly, combined feed 840 may be associated with a first set of one or more users of the SNS and a second set of one or more users of the SNS. The first set may be users that the first user has indicated to be associated with the primary feed. For example, each user in the first set may have a bidirectional connection with the first user. For another example, the first user may select a subset of one or more users that have a bidirectional connection with the first user to be associated with the primary feed. The second set may be users that the first user has indicated to be associated with the secondary feed. For example, each user in the second set may have been added by the first user to an audience of the first user (which would add a unidirectional connection from the user to the first user). The second set may include less users than the first set.

Combined feed 840 may include content associated with the first set. For example, combined feed 840 may include fifth content 832, which may have been posted by a second user of the SNS. Other examples of content that may be included in combined feed 840 from the primary feed include second content 824 (posted by a third user of the SNS) and third content 826 (posted by a fifth user of the SNS). While content from three users is illustrated to be associated with the primary feed in combined feed 840, it should be recognized that content from more or less users may be included.

Combined feed 840 may also include content associated with the second set. For example, combined feed 840 may include fifth content 832, which may have been posted by the second user. Other examples of content that may be included in combined feed 840 from the secondary feed include sixth content 834, which may have been posted by the third user. While content from two users is illustrated to be associated with the secondary feed in combined feed 840, it should be recognized that content from more or less users may be included.

When the first user navigates to the user interface, social networking application 810 may request content from the primary feed and/or the secondary feed. In response to the request, the SNS may send content (e.g., first content 822) to be populated in combined feed 840. In some examples, combined feed 840 may be scrollable such that some content is hidden by view. When combined feed 840 is scrollable, some content that is hidden may be retrieved from the SNS when combined feed 840 is scrolled.

In some examples, the next content to add to combined feed 840 may be determined by a proximity to the current time that content was posted. For example, content may be added to combined feed 840 such that the most recent content is at the top, no matter if the most recent content is from the primary feed or the secondary feed. Other methods of determining the next content may be used, such as taking in account a profile of the first user.

In some examples, content included in combined feed 840 may be posted by a user from their own primary feed or secondary feed. In such examples, embodiments allow users to cross post between the two feeds to share content to particular sets of users. Also, multiple pieces of content from a single user may be included in combined feed 840 (from the primary feed or the secondary feed). In addition to content, an indication may be added to the content in combined feed 840 to indicate that the content is associated with a particular feed (e.g., the primary feed or the secondary feed). For example, indicator 842 may indicate that content is associated with the secondary feed, and indicator 844 may indicate that content is associated with the primary feed.

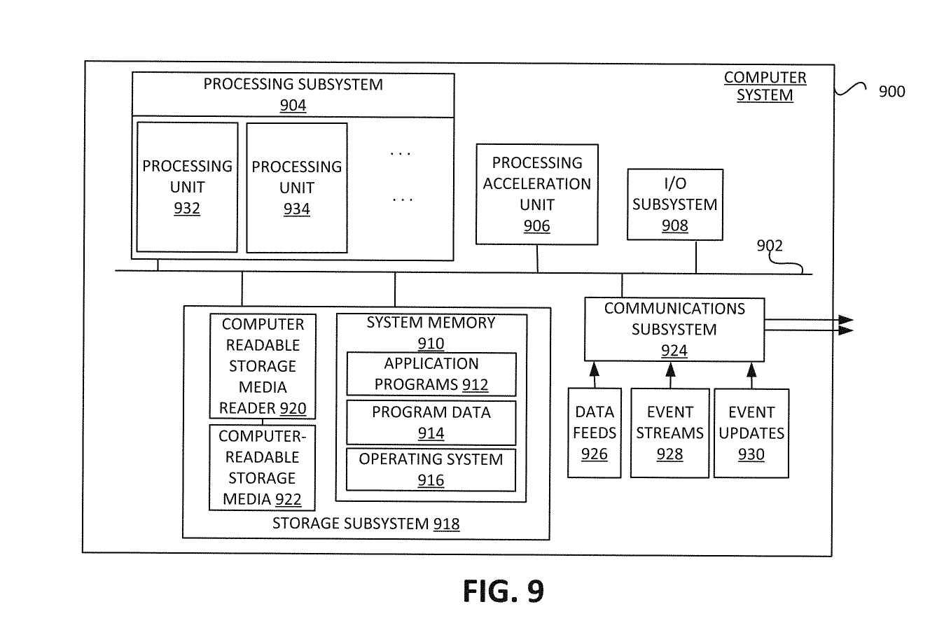

FIG. 9 illustrates an example of computer system 900, which may be used to implement certain embodiments described herein. For example, in some embodiments, computer system 900 may be used to implement any of the systems, servers, devices, or the like described above. As shown in FIG. 9, computer system 900 includes processing subsystem 904, which communicates with a number of other subsystems via bus subsystem 902. These other subsystems may include processing acceleration unit 906, I/O subsystem 908, storage subsystem 918, and communications subsystem 924. Storage subsystem 918 may include non-transitory computer-readable storage media including storage media 922 and system memory 910.

Bus subsystem 902 provides a mechanism for allowing the various components and subsystems of computer system 900 to communicate with each other. Although bus subsystem 902 is shown schematically as a single bus, alternative embodiments of bus subsystem 902 may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may include single core and/or multicore processors. The processing resources of computer system 900 may be organized into one or more processing units 932, 934, etc. A processing unit may include one or more processors, one or more cores from the same or different processors, a combination of cores and processors, or other combinations of cores and processors. In some embodiments, processing subsystem 904 may include one or more special purpose co-processors such as graphics processors, digital signal processors (DSPs), or the like. In some embodiments, some or all of the processing units of processing subsystem 904 may be implemented using customized circuits, such as application specific integrated circuits (ASICs), or field programmable gate arrays (FPGAs).

In some embodiments, the processing units in processing subsystem 904 may execute instructions stored in system memory 910 or on computer readable storage media 922. In various embodiments, the processing units may execute a variety of programs or code instructions and may maintain multiple concurrently executing programs or processes. At any given time, some or all of the program code to be executed may be resident in system memory 910 and/or on computer-readable storage media 922 including potentially on one or more storage devices. Through suitable programming, processing subsystem 904 may provide various functionalities described above. In instances where computer system 900 is executing one or more virtual machines, one or more processing units may be allocated to each virtual machine.

In certain embodiments, processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 900 to a user or other computer system. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some embodiments. Storage subsystem 918 may store software (e.g., programs, code modules, instructions) that, when executed by processing subsystem 904, provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes system memory 910 and computer-readable storage media 922. System memory 910 may include a number of memories, including (1) a volatile main random access memory (RAM) for storage of instructions and data during program execution and (2) a non-volatile read only memory (ROM) or flash memory in which fixed instructions are stored. In some implementations, a basic input/output system (BIOS), including the basic routines that help to transfer information between elements within computer system 900, such as during start-up, may typically be stored in the ROM. The RAM typically includes data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and operating system 916.

Computer-readable storage media 922 may store programming and data constructs that provide the functionality of some embodiments. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, DVD, a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 918 may also include computer-readable storage media reader 920 that may further be connected to computer-readable storage media 922. Reader 920 may receive and be configured to read data from a memory device such as a disk, a flash drive, etc.

In certain embodiments, computer system 900 may support virtualization technologies, including but not limited to virtualization of processing and memory resources. For example, computer system 900 may provide support for executing one or more virtual machines. In certain embodiments, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices.

Communication subsystem 924 may support both wired and/or wireless communication protocols. For example, in certain embodiments, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 924 may provide wired network connectivity (e.g., Ethernet) in addition to or instead of a wireless interface.

Communication subsystem 924 may receive and transmit data in various forms. For example, in some embodiments, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as web feeds and/or real-time updates from one or more third party information sources.

In certain embodiments, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 may be one of various types, including a handheld portable device, a wearable device, a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art will appreciate other ways and/or methods to implement the various embodiments.

Some embodiments described herein make use of social networking data that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well.

In the preceding description, for the purposes of explanation, specific details are set forth in order to provide a thorough understanding of examples of the disclosure. However, it should be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may have been shown without necessary detail in order to avoid obscuring the examples. The figures and description are not intended to be restrictive.

The description provides examples only, and is not intended to limit the scope, applicability, or configuration of the disclosure. Rather, the description of the examples provides those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable storage medium” or “computer-readable storage medium” includes, but is not limited to, portable or non-portable storage devices, optical storage devices, and various other mediums capable of storing, including, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some embodiments, the systems may be configured as a distributed system where one or more components of the system are distributed across one or more networks such as in a cloud computing system.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The terms and expressions that have been employed in this disclosure are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product including computer program code or instructions executable by one or more processors for performing any or all of the steps, operations, or processes described in this disclosure, where the computer program may be stored on a non-transitory computer readable medium. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
receiving, from a first user of a social networking system, a request to add a second user of the social networking system to an audience of the first user; and
in response to the request, adding a unidirectional connection from the first user to the second user in a social graph stored by the social networking system, the unidirectional connection establishing that content is able to be sent from the first user to the second user based upon the unidirectional connection, the unidirectional connection further establishing that content is not able to be sent from the second user to the first user based upon the unidirectional connection.

2. The method of claim 1, wherein a plurality of feeds are associated with the second user, wherein the plurality of feeds include a first feed and a second feed, wherein the first feed includes content sent based upon a bidirectional connection between a user of the social networking system and the second user, and wherein the second feed includes content sent based upon a unidirectional connection from a user of the social networking system to the second user.

3. The method of claim 2, wherein the second feed includes content from a plurality of users of the social networking system, and wherein each of the plurality of users has added the second user to their own audience.

4. The method of claim 1, wherein the unidirectional connection is added to the social graph without an action by the second user.

5. The method of claim 1, wherein the first user and the second user are connected by a bidirectional connection in the social graph in addition to the unidirectional connection, wherein the bidirectional connection is established at the same time or before the unidirectional connection, wherein the bidirectional connection establishes that content is able to be sent from the first user to the second user based upon the bidirectional connection, and wherein the bidirectional connection further establishes that content is able to be sent from the second user to the first user based upon the bidirectional connection.

6. The method of claim 5, wherein the social graph includes connections between users of the social networking system.

7. The method of claim 6, wherein a bidirectional connection is included in the social graph, and wherein the bidirectional connection establishes that content is able to be sent between a user of the social networking system and another user of the social networking system based upon the bidirectional connection.

8. A method comprising:
receiving content sent to an audience of a first user of a social networking system, the audience including one or more users of the social networking system, each user of the one or more users connected to the first user by a unidirectional connection from the first user to the user, the unidirectional connection establishing that content is able to be sent from the first user to the user based upon the unidirectional connection, the unidirectional connection further establishing that content is not able to be sent from the user to the first user based upon the unidirectional connection;
identifying the one or more users included in the audience; and
for each user of the one or more users, sending the content to the user based upon a unidirectional connection from the first user to the user.

9. The method of claim 8, wherein the unidirectional connection is established from the first user to the user without an action by the user.

10. The method of claim 8, wherein each of the one or more users are also connected to the first user by a bidirectional connection, wherein the bidirectional connection is established at the same time or before the unidirectional connection, wherein the bidirectional connection establishes that content is able to be sent from the first user to the user based upon the bidirectional connection, and wherein the bidirectional connection further establishes that content is able to be sent from the user to the first user based upon the bidirectional connection.

11. The method of claim 8, wherein a plurality of feeds are associated with the first user, wherein the plurality of feeds include a first feed and a second feed, wherein the first feed includes content sent based upon a bidirectional connection between the first user and another user, and wherein the second feed includes content sent based upon a unidirectional connection from another user to the first user.

12. The method of claim 11, wherein the first user sends the content to the audience from the first feed.

13. The method of claim 11, wherein the second feed includes content from a plurality of users of the social networking system that have added the first user to their own audiences.

14. The method of claim 8, wherein the content is included in a feed associated with a user for an amount of time, wherein upon expiration of the time, the content is removed from the feed such that the user is not able to view the content.

15. The method of claim 14, wherein when the content is removed from the feed associated with the user, the content is configured such that only the first user may view the content.

16. A non-transitory computer-readable storage medium storing a plurality of instructions executable by one or more processors, the plurality of instructions when executed by the one or more processors cause the one or more processors to:
receive, from a first user of a social networking system, a request to add a second user of the social networking system to an audience of the first user; and
in response to the request, add a unidirectional connection from the first user to the second user in a social graph stored by the social networking system, the unidirectional connection establishing that content is able to be sent from the first user to the second user based upon the unidirectional connection, the unidirectional connection further establishing that content is not able to be sent from the second user to the first user based upon the unidirectional connection.

17. The non-transitory computer-readable storage medium of claim 16, wherein a plurality of feeds are associated with the second user, wherein the plurality of feeds include a first feed and a second feed, wherein the first feed includes content sent based upon a bidirectional connection between a user of the social networking system and the second user, wherein the second feed includes content sent based upon a unidirectional connection from a user of the social networking system to the second user, wherein the second feed includes content from a plurality of users of the social networking system, and wherein each of the plurality of users has added the second user to their own audience.

18. The non-transitory computer-readable storage medium of claim 16, wherein the unidirectional connection is added to the social graph without an action by the second user.

19. The non-transitory computer-readable storage medium of claim 16, wherein the first user and the second user are connected by a bidirectional connection in the social graph in addition to the unidirectional connection, wherein the bidirectional connection is established at the same time or before the unidirectional connection, wherein the bidirectional connection establishes that content is able to be sent from the first user to the second user based upon the bidirectional connection, and wherein the bidirectional connection further establishes that content is able to be sent from the second user to the first user based upon the bidirectional connection.

20. The non-transitory computer-readable storage medium of claim 19, wherein a bidirectional connection is included in the social graph, and wherein the bidirectional connection establishes that content is able to be sent between a user of the social networking system and another user of the social networking system based upon the bidirectional connection.
